(19) United States
(12) Patent Application Publication
(10) Pub. No.: US 2005/0200796 A1
(43) Pub. Date: Sep. 15, 2005

(54) LED lighting apparatus

(76) Inventors: Hiroki Iwanaga, Yokohama-shi (JP); Akio Amano, Kawasaki-shi (JP); Yukio Takahagi, Tokyo (JP); Koichi Harada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/052,223

(22) Filed: Feb. 8, 2005

(30) Foreign Application Priority Data
Feb. 9, 2004 (JP) 2004-032461
Feb. 25, 2004 (JP) 2004-049751

(51) Int. Cl. G02F 1/1345

(52) U.S. Cl. 349/149

(57) ABSTRACT

An LED lighting apparatus which comprises an LED chip, and a light-emitting layer which is disposed on a light-emitting side of the LED chip and including an organic fluorescent substance and a matrix containing, as a main component, a fluorine-based or cyanobiphenyl-based liquid crystalline compound exhibiting a nematic phase.

### CROSS-REFERENCE TO RELATED APPLICATIONS

This application is based upon and claims the benefit of priority from prior Japanese Patent Applications No. 2004-032461, filed Feb. 9, 2004; and No. 2004-049751, filed Feb. 25, 2004, the entire contents of both of which are incorporated herein by reference.

### BACKGROUND OF THE INVENTION

1. Field of the Invention

The present invention relates to an LED lighting apparatus provided with a light-emitting diode chip and a fluorescent layer.

2. Description of the Related Art

At present, there are great expectations of it being possible to employ, as a high intensity lighting system, an LED lighting apparatus which comprises, as a light source, a light-emitting diode (LED) chip and, as a light-emitting layer, a fluorescent layer containing a rare earth complex fluorescent substance or an organic fluorescent substance such as a polymeric fluorescent substance. Therefore, extensive studies and developments are now made on the LED lighting apparatus. The fluorescent layer which is the most characteristic feature of this LED lighting apparatus is formed of a matrix and an organic fluorescent substance dispersed in the matrix. This lighting system is based on the principle that the light emitted from an LED chip is converted into light of a different wavelength by the effect of the organic fluorescent substance, thereby emitting light.

The matrix is required to be excellent in transmittancy, photochemical stability as well as other characteristics such as oxygen barrier properties, hydrophobicity, etc. At present, fluoropolymers are considered promising for use as a matrix having these characteristics.

However, the fluoropolymers are accompanied with the problem that since the dispersibility of organic fluorescent substance in the fluoropolymers is poor, the scattering of light is generated in the light-emitting layer which is formed of a fluoropolymer containing an organic fluorescent substance, thus degrading the luminous efficiency of the lighting system.

With a view to solving the aforementioned problem, a method is proposed in Japanese Laid-open Patent Publication (Kokai) No. 2001-279236 wherein the polymerizing synthesis of polymer for forming a matrix is performed in the presence of an organic fluorescent substance to thereby improve the dispersion of the organic fluorescent substance. However, the polymerizing synthesis of polymer according to this method is useful only when the polymer is of a relatively simple structure such as polyester or polyamide. However, the matrix formed of these polymers is poor in oxygen barrier properties, hydrophobicity, etc., thus degrading the life of the lighting system. Further, this method is also accompanied with the problem that the kinds of organic fluorescent substance which are stable in the polymerization reaction are much limited in number, thus making this method much limitative in flexibility.

Further, since the matrix thus produced is high in viscosity, there is a further problem that voids (may contain air) are permitted to be generated in the fluorescent layer on the occasion of forming the fluorescent layer. Since the voids in the fluorescent layer would become a cause for generating light scattering, the generation of the voids would lead to the deterioration of luminous efficiency of the LED lighting apparatus. In particular, the organic fluorescent substance existing in the vicinity of the LED chip has great influences on the luminescence of the fluorescent layer as a whole, and moreover, a region of the fluorescent layer located in the vicinity of the LED chip is exposed to high intensities of light and heat. As a result, this region of the fluorescent layer is liable to deteriorate, resulting in the generation of large voids with time and in the deterioration of life of the LED lighting apparatus.

It may be conceivable, in order to solve this problem, to lower the viscosity of the matrix to thereby enhance the fluidity of the matrix. Although various kinds of polymers are examined for use as the matrix at present, no one has succeeded as yet to find a polymer having such an enhanced fluidity without sacrificing the properties which the matrix is desired to have.

Meanwhile, the LED lighting apparatus where an organic fluorescent substance is employed as a fluorescent layer has not yet been put to practical use for the following problems.

1) In the case of the luminescent device where a near-ultraviolet LED is employed as a light source, as is currently increasingly employed, and where luminous substances consisting of R, G and B, consisting of R, Ye and B, or consisting of R, Ye, G and B are employed, if the organic fluorescent substances are employed as these luminous substances, the organic fluorescent substances are caused to deteriorate extremely by the effects of ultraviolet rays since organic compounds are generally durability of organic compounds to ultraviolet rays. In particular, when these organic compounds employed therein exhibit absorption of light based on n-π* transition in the near-ultraviolet zone, these organic compounds would rapidly deteriorated.

2) There are possibilities that organic fluorescent substance may exhibit the fluctuation of fluorescence spectrum depending on the concentration thereof, so that it is difficult to control the spectrum thereof. Furthermore, the fluorescent intensity of organic fluorescent substance may also fluctuate depending on the concentration thereof, so that the concentration quenching would be caused to be generated at a high-concentration zone thereof.

3) The fluorescence spectrum of an organic fluorescent substance may fluctuate depending on the kinds of polymer employed for dispersing the organic fluorescent substance.

4) Generally, in the presence of oxygen and water, the deterioration due to the photochemical reaction of an organic fluorescent substance would be promoted.

Incidentally, there is also known an organic electroluminescence element where organic fluorescent substances are employed (for example, see Japanese Laid-open Patent Publication (Kokai) No. 2001-284049).

Further, in recent years, a fluorescent substance made of rare earth complexes is increasingly having taken notice of (for example, see JP Laid-open Patent—Publication (Kokai) No. 2002-173622). To begin with, fluorescent substances made of rare earth complexes are advantageous in the following respects as compared with ordinary organic fluorescent substances.

1) The emission wavelength of rare earth complexes is peculiar to rare earth elements and the luminescence spectrum is quite stable, i.e., free from any influence of colorant concentration and from the kinds of polymer into which fluorescent substances are dispersed.

2) Although the ligand of rare earth complexes is an organic compound, once the ligand is turned into an excited state as it absorbs light, the ligand is permitted to return to its ground state due to the shift of energy to the central element, so that the chance of generating an irreversible chemical change from the excited state can be minimized. As a result, the fluorescent substance is expected to exhibit excellent resistance to ultraviolet rays.

However, since the rare earth complexes are constructed such that the central rare earth element is bonded, through a so-called coordinate bond between a Lewis acid and a Lewis base, to a ligand, the rare earth complexes are prone to deteriorate due to the exchange of ligand. Although this ligand exchange is caused to occur under a strong acidic or strong basic condition, since this ligand exchange is further promoted by the presence of water or by the generation of optically degraded products of polymer, the penetration of water into the light-emitting layer would become a problem to be coped with in particular. Incidentally, other than the fluorescent substance made of rare earth complexes, there are many kinds of compounds among organic fluorescent substance and inorganic fluorescent substance, the characteristics of which are caused to deteriorate due to moisture absorption.

On the other hand, there are also known examples where silicone resins are employed as a sealing layer (for example, see Japanese Laid-open Patent Publication (Kokai) No. 2002-327115). However, since silicone resins are permeable to water vapor and hence it is difficult to prevent the penetration of water molecules which behaves as a gaseous phase, there is a problem that the sealing layer made of silicone resins is poor in damp proof effect. Further, there is also known a method of purging the LED lighting apparatus entirely by making use of an inert gas such as nitrogen gas. This method however would lead to an increase of manufacturing cost of the LED lighting apparatus.

### BRIEF SUMMARY OF THE INVENTION

One of the objects of the present invention is to provide an LED lighting apparatus which is high luminous efficiency and long in life.

According to one aspect of the present invention, there is provided an LED lighting apparatus which comprises an LED chip, and a light-emitting layer which is disposed on a light-emitting side of the LED chip and including an organic fluorescent substance and a matrix containing, as a main component, a fluorine-based or cyanobiphenyl-based liquid crystalline compound exhibiting a nematic phase.

According to another aspect of the present invention, there is provided an LED lighting apparatus which comprises an LED chip; a light-emitting layer which is disposed on a light-emitting side of the LED chip and contains an organic fluorescent substance; and a damp proof layer which is disposed on a surface of the light-emitting layer which is located opposite to the surface facing the LED chip and contains a compound which is liquid or exhibits a liquid crystal phase at room temperature. The room temperature is, for example, 10 to 35° C.

### BRIEF DESCRIPTION OF THE SEVERAL VIEWS OF THE DRAWING

FIG. 1 is a cross-sectional view illustrating a surface-mounting type LED lighting apparatus representing one example of the LED lighting apparatus according to a first embodiment of the present invention;

FIG. 2 is a schematic cross-sectional view of the LED lighting apparatus shown in FIG. 1 for explaining the condition of a fluorescent layer after the lighting thereof for 3000 hours;

FIG. 3 is a schematic cross-sectional view of the LED lighting apparatus according to a comparative example for explaining the condition of the fluorescent layer after the lighting thereof for 3000 hours;

FIG. 4 is a cross-sectional view illustrating an LED lighting apparatus according to a second embodiment of the present invention;

FIG. 5 is a cross-sectional view illustrating another example of the LED lighting apparatus according to the second embodiment of the present invention; and

FIG. 6 is a cross-sectional view illustrating a further example of the LED lighting apparatus according to the second embodiment of the present invention.

### DETAILED DESCRIPTION OF THE INVENTION

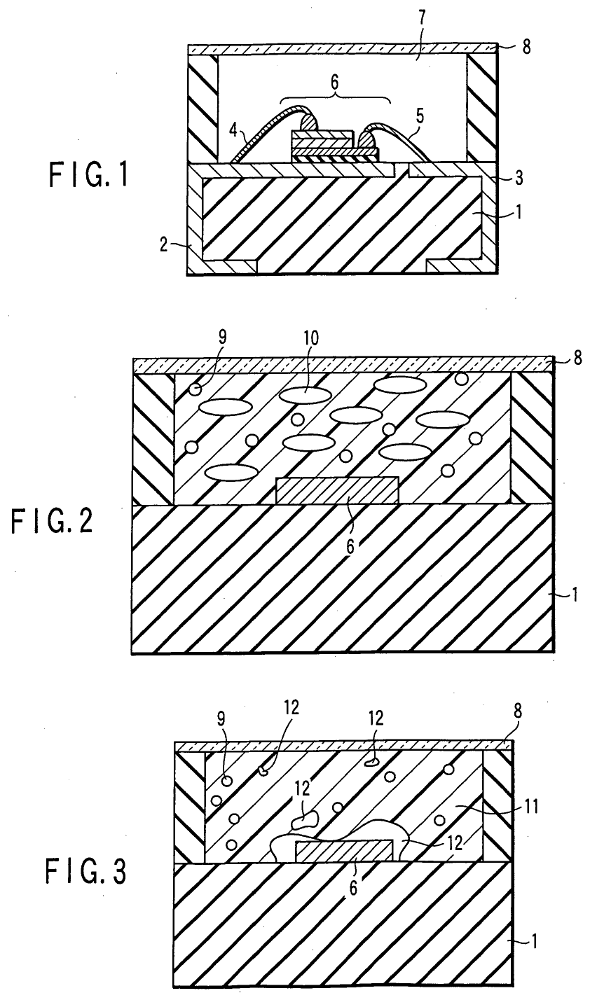

One example of the LED lighting apparatus according to the first embodiment of the present invention will be explained with reference to FIG. 1. FIG. 1 shows a cross-sectional view illustrating a surface-mounting type LED lighting apparatus representing the first embodiment of the present invention.

Referring to FIG. 1, a base body 1 has a U-shaped top surface, forming a recessed portion which is covered by a plate-like translucent covering member 8. Inside this recessed portion of the base body 1 which is covered by this translucent covering member 8, there is disposed a fluorescent layer 7. Below this fluorescent layer 7, there is disposed an LED chip 6. This LED chip 6 has an upper electrode which is connected via a first wire 4 with a first electrode 2. This LED chip 6 has also a lower electrode which is connected via a second wire 5 with a second electrode 3. The first electrode 2 is extended from a left bottom portion of the fluorescent layer 7 via the side wall of the base body 1 to a bottom portion of the base body 1, thus forming a horizontally inclined U-shaped configuration. The second electrode 3 is extended from a right bottom portion of the fluorescent layer 7 via the side wall of the base body 1 to a bottom portion of the base body 1, thus forming a horizontally inclined U-shaped configuration.

The LED lighting apparatus according to this embodiment is operated based on the principle that electric energy applied thereto is directly converted by the LED chip 6 into a light energy, which is then converted by the organic fluorescent substance included in the fluorescent layer 7 into a light of different wavelength, thus emitting visible light.

Incidentally, in FIG. 1, although the present embodiment is explained with reference to the surface-mounting type LED lighting apparatus, The present embodiment is also applicable likewise to a shell type LED lighting apparatus.

Next, the fluorescent layer 7, LED chip 6 and translucent covering member 8 of the LED lighting apparatus illustrated above will be explained.

(1) Fluorescent Layer 7:

This fluorescent layer 7 contains at least a matrix and an organic fluorescent substance dispersed in the matrix, each of which will be explained respectively as follows.

(a) Matrix:

The matrix to be employed in the LED lighting apparatus according to this embodiment contains, as a main component, a fluorine-based or cyanobiphenyl-based liquid crystalline compound exhibiting a nematic phase.

Generally, polymers can be employed as a matrix to be included in the fluorescent layer. While the interface of liquid crystalline compounds is gapless due to their specific structures where long and slender molecules are regularly orientated, the interface of polymers is abundant with gaps due to their long chain structures. Therefore, as compared with the polymers, the liquid crystalline compounds are more excellent in preventing oxygen molecule and water molecule from penetrating into the matrix, and hence the liquid crystalline compounds are more excellent in oxygen barrier properties and in hydrophobicity.

The liquid crystalline compounds exhibiting a nematic phase are low in viscosity and hence excellent in fluidity. Therefore, it is possible, with the employment of the liquid crystalline compounds, to minimize the local deterioration of the fluorescent layer. Further, it is also possible, with the employment of the liquid crystalline compounds, to suppress the generation of voids on forming the fluorescent layer and to suppress the scattering of light. Incidentally, the fluidity of the liquid crystalline compounds may be exhibited only when the liquid crystalline compounds are heated. In this case, it may become possible, through the heating of the liquid crystalline compounds at a temperature not higher than that may deteriorate the LED lighting apparatus, to enhance the luminous intensity of the LED lighting apparatus even when the luminous intensity thereof has been once degraded.

Furthermore, most of the liquid crystalline compounds exhibiting a nematic phase are small in refractive index anisotropy, thereby making it possible to minimize the scattering of light.

Incidentally, the liquid crystalline compounds other than the liquid crystalline compounds exhibiting a nematic phase, for example, liquid crystalline compounds exhibiting a smectic phase are high in viscosity, so that these liquid crystalline compounds are not desirable for employing as a matrix of the fluorescent layer in the LED lighting apparatus according to this embodiment. Further, in the case of the liquid crystalline compounds exhibiting a cholesteric phase, since it is difficult to obtain one which is low in refractive index anisotropy, these liquid crystalline compounds are not desirable for employing as a matrix of the fluorescent layer in the LED lighting apparatus according to this embodiment.

When liquid crystalline compounds include fluorine group or cyanobiphenyl group, the dispersibility of organic fluorescent substances would be enhanced, thus making it possible to minimize the scattering of light. Further, since fluorine group and cyanobiphenyl group are repulsive against water molecule, it is possible to enhance the hydrophobicity of the fluorescent layer.

For these reasons, by the employment of a matrix containing, as a main component, a fluorine-based or cyanobiphenyl-based liquid crystalline compound which is exhibiting a nematic phase, it is possible to provide an LED lighting apparatus which is capable of minimizing the scattering of light and high in luminous efficiency. Further, since the matrix comprising a fluorine-based or cyanobiphenyl-based liquid crystalline compound is excellent in fluidity, high in oxygen barrier properties and high in hydrophobicity, it is possible to provide an LED lighting apparatus of long life.

Compared with the cyanobiphenyl-based liquid crystalline compound, the fluorine-based liquid crystalline compound is higher in hydrophobicity and hence more preferable for use. Further, the employment of a fluorine-based liquid crystalline compound is more preferable because of its relatively small refractive index anisotropy.

The liquid crystalline compounds may be provided with the following properties.

Namely, the liquid crystalline compounds may be as small in refractive index anisotropy as possible. More specifically, when the refractive index anisotropy of the liquid crystalline compounds is confined to not more than 0.20, the scattering of light can be minimized, thereby making it possible to provide an LED lighting apparatus which is high in luminous efficiency.

The NI phase transition point (nematic anisotropic phase transition point) of the liquid crystalline compounds may be not lower than 70° C. When the NI phase transition point of the liquid crystalline compounds is limited as mentioned above, the phenomenon of phase transition from a nematic phase to an isotropic phase due to the evolution of heat of LED lighting apparatus, i.e. the phase change of the liquid crystalline compounds from a regularly arrayed state of molecule to a disordered state of molecule can be suppressed, thereby making it possible to maintain the aforementioned properties inherent to the liquid crystalline compounds.

Further, ε//(the dielectric constant in the direction parallel to the molecular axis of liquid crystalline compound) of the liquid crystalline compounds may be not less than 6 in order to enhance the dispersibility of an organic fluorescent substance in the matrix.

The following are specific examples of the matrix that can be employed in the LED lighting apparatus according to this embodiment.

As for the fluorine-based liquid crystalline compounds exhibiting a nematic phase, the compounds represented by the following formulas (1), (2) and (3) can be employed. As for the cyanobiphenyl-based liquid crystalline compounds exhibiting a nematic phase, the compounds represented by the following formulas (4), (5), (6) and (7) can be employed.

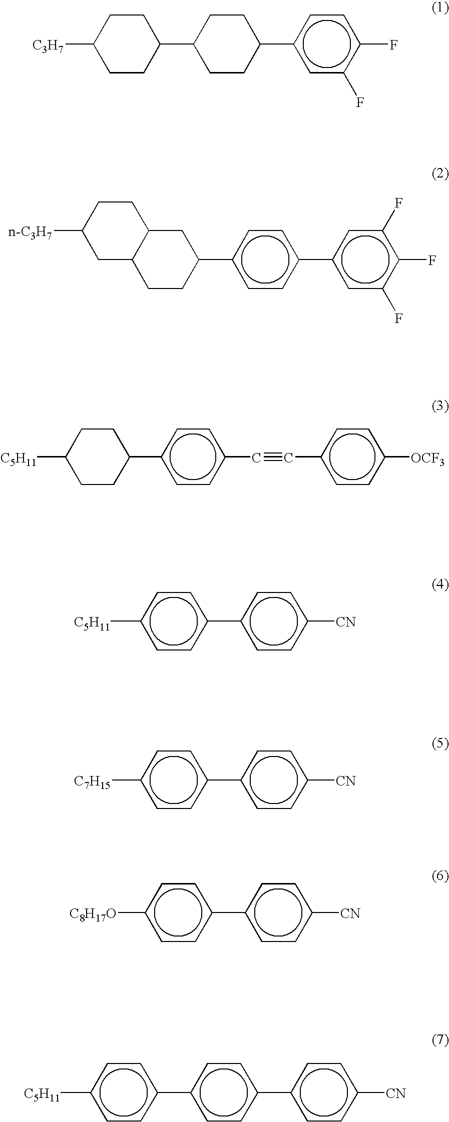

Incidentally, additives such as a solvent, a dispersant, etc. may be added to the matrix to be employed in the LED lighting apparatus according to this embodiment as long as the quantity thereof is limited to such that there are no possibilities of degrading the properties of the matrix.

(b) Organic Fluorescent Substance:

The organic fluorescent substances to be employed in the LED lighting apparatus according to this embodiment are rare earth complex fluorescent substances or polymeric fluorescent substances.

First of all, the details about the rare earth complex fluorescent substances will be explained.

The rare earth complex fluorescent substances are excellent in dispersibility to the matrix to be employed in this embodiment and having a high polarity. Further, since the rare earth complex fluorescent substances are highly reactive to water and liable to undergo a photooxidation reaction, they are especially effective to the matrix to be employed in this embodiment and exhibiting high hydrophobicity and high oxygen barrier properties. Incidentally, the rare earth complex fluorescent substances exhibit a constant luminous wavelength which will be hardly fluctuated by the kinds or concentrations of the matrix. Since the rare earth complex fluorescent substances are high in flexibilities in use, the rare earth complex fluorescent substances can be employed in the case to manufacture a white LED lighting apparatus by mixing together several kinds of the fluorescent substances. Further, since the rare earth complex fluorescent substances are high in UV resistance, the rare earth complex fluorescent substances can be employed especially in the case where an LED chip whose luminous wavelength is located in the near-ultraviolet zone is employed.

Among the rare earth complex fluorescent substances, Eu complex fluorescent substance is especially preferable for use.

The Eu complex fluorescent substance is exhibiting a red luminous wavelength of 616 nm. When this Eu complex fluorescent substance is employed as a fluorescent substance for R in a white LED lighting apparatus where fluorescent substances for R, G and B are employed together, there will be derived the advantage that red color rendering properties can be enhanced as compared with the conventional inorganic white LED lighting apparatus.

The Eu complex fluorescent substance which is preferable for use in the LED lighting apparatus according to this embodiment is provided with at least one of the ligands represented by the following formula (8) or (9) and one ligand represented by the following formula (10). Incidentally, if the number of the ligands represented by the formula (8) to be concurrently included in the Eu complex fluorescent substance is two or more, the ligands represented by the formula (8) may be the same or different from each other. This conception is also applicable to the ligands represented by the formulas (9) and (10). 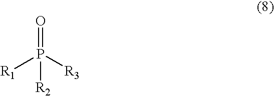
(where R₁, R₂ and R₃ may be the same or different and are individually alkyl group, alkoxy group, phenyl group, substituted phenyl group, phenoxy group or substituted phenoxy group, said alkyl and alkoxy groups each having not more than 20 carbon atoms.) 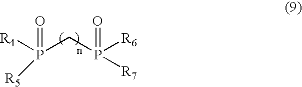
(where R₄, R₅, R₆ and R₇ may be the same or different and are individually alkyl group, alkoxy group, phenyl group, substituted phenyl group, phenoxy group or substituted phenoxy group, said alkyl and alkoxy groups each having not more than 20 carbon atoms; n is an integer ranging from 1 to 20, more preferably 2 to 4.) 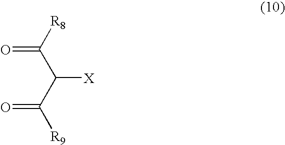
(where R₈ and R₉ may be the same or different and are individually alkyl group, alkoxy group, phenyl group, substituted phenyl group, phenoxy group or substituted phenoxy group, said alkyl and alkoxy groups each having not more than 20 carbon atoms; X is a group selected from the group consisting of H, D, F and alkyl group.)

These Eu complex fluorescent substances mentioned above are exhibiting a high luminous intensity.

Incidentally, in the ligands represented by the formulas (8) to (10), if the number of carbon atoms in R₁ to R₉ is more than 20, the solubility of the Eu complex fluorescent substances to the matrix may be more likely to be degraded.

Further, in the ligand represented by the formula (9), the number of “n” may be confined within the range of 2 to 4. When the number of “n” is limited to this range, the synthesis of rare earth complex would be facilitated.

In the ligand represented by the formula (10), when X is D or F, it would be effective in suppressing the deterioration of luminous intensity that may be caused by the vibration of C—H bond. Further, when X is alkyl group, it may be effective in suppressing the substitution reaction of H for X employed as an active moiety.

The Eu complex fluorescent substances may contain two ligands represented by the formula (8), or the ligands represented by the formula (9), and three ligands represented by the formula (10).

The Eu complex fluorescent substances mentioned above are excellent in asymmetry of ligand field. As a result, it is now possible to enhance the forbidden transition, resulting in the improvement of molecular extinction coefficient of the Eu complex fluorescent substances, thus further enhancing the luminous intensity. Further, since the asymmetry of the Eu complex fluorescent substances can be enhanced and hence the crystallization of the Eu complex fluorescent substances can be suppressed, the dispersibility of the Eu complex fluorescent substances into the matrix can be further enhanced.

The Eu complex fluorescent substances may contain the ligand represented by the formula (8) where R₁, R₂ and R₃ are individually phenyl group or substituted phenyl group, the ligand represented by the formula (8) where R₁, R₂ and R₃ are individually alkyl group, and three ligands represented by the formula (10) where R₈ is perfluoroalkyl group, R₉ is alkyl group, and X is a group selected from H, D and F.

Since two ligands represented by the formula (8) employed herein differ from each other, the asymmetry of ligand field in the Eu complex fluorescent substances can be further enhanced. As a result, these Eu complex fluorescent substances can be further enhanced in luminous intensity and in dispersibility thereof in the matrix.

The Eu complex fluorescent substances may contain the ligand represented by the formula (9) where R₄, R₅, R₆ and R₇ are individually alkyl group, phenyl group or substituted phenyl group; and three ligands represented by the formula (10) where R₈ is perfluoroalkyl group, R₉ is alkyl group, and X is a group selected from H, D and F.

Since diphosphine dioxide represented by the formula (9) is a bidentate ligand, the stability of the Eu complex fluorescent substances can be enhanced, thus contributing to the increase of life of the LED lighting apparatus. Further, since the groups of R₄, R₅, R₆ and R₇ are respectively formed of the aforementioned substituent group, the luminous intensity of the Eu complex fluorescent substances can be further enhanced.

Next, details about the polymeric fluorescent substances will be given.

Since the polymeric fluorescent substances are excellent in water resistance and in heat resistance and wide in the range of luminous wavelength, the polymeric fluorescent substances are exhibiting a high luminous intensity. Further, the luminous wavelength of the polymeric fluorescent substances is variable and varies depending on the concentration thereof and on the matrix. Therefore, by adjusting the luminous wavelength of the polymeric fluorescent substances to a wavelength zone having a high sensitivity in the luminous reflectance curve, it is possible to derive a high luminous intensity.

The average molecular weight of the polymeric fluorescent substances may be confined within the range of 5,000 to 300,000. By limiting the average molecular weight of the polymeric fluorescent substances to not less than 5,000, the stability of the polymeric fluorescent substances can be enhanced. On the other hand, by limiting the average molecular weight of the polymeric fluorescent substances to not more than 300,000, the dispersibility of the polymeric fluorescent substances into the matrix can be enhanced.

The polymeric fluorescent substances represented by the following formula (11) and having an average molecular weight ranging from 5,000 to 300,000 are especially preferable since it is possible, according to these polymeric fluorescent substances, to especially increase the range of luminous wavelength. Incidentally, R₁₀, R₁₁, R₁₂ and R₁₃ in the following formula (11) may be the same or different from each other. 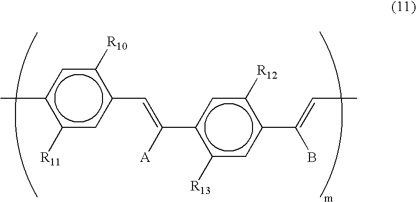
(where R₁₀, R₁₁, R₁₂ and R₁₃ may be the same or different and are individually alkyl group or alkoxy group; A and B may be the same or different and are individually cyano group or alkyl group; and m is a natural number.)

The luminous wavelength of the polymeric fluorescent substances represented by the following formula (11) can be adjusted as follows. When the electron density of the carbon atoms to which groups A and B are bonded is relatively large, these groups A and B may be turned into cyano group so as to shift the luminous wavelength to a longer wavelength side, or alternatively, these groups A and B may be turned into alkyl group so as to shift the luminous wavelength to a shorter wavelength side. On the other hand, when the electron density of the carbon atoms to which groups A and B are bonded is relatively small, the shifting direction of the luminous wavelength would become opposite to that mentioned above. Incidentally, the electron density of the carbon atoms to which groups A and B are bonded has influence on the groups R₁₀, R₁₁, R₁₂ and R₁₃.

The polymeric fluorescent substances represented by the following formula (12) and having an average molecular weight ranging from 5,000 to 300,000 are preferable in the respect that these polymeric fluorescent substances would be provided with well-balanced properties which the aforementioned polymeric fluorescent substances inherently have. Incidentally, R₁₄ and R₁₅ in the following formula (12) may be the same or different from each other. The aromatic group representing C may be formed of a fused ring or an aromatic group having a substituent group. 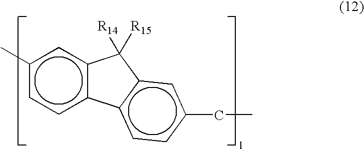
(where R₁₄ and R₁₅ may be the same or different and are individually alkyl group, alkoxy group, phenyl group or substituent phenyl group; C is aromatic group; and 1 is a natural number).

The luminous wavelength of the polymeric fluorescent substances represented by the formula (12) tends to shift to a longer wavelength side as the number of the aromatic group representing C is increased.

(2) LED Chip 6:

As for the luminous wavelength of the LED chip, there is no limitation as long as it can be absorbed by an organic fluorescent substance. Incidentally, the organic fluorescent substances to be employed in the LED lighting apparatus according to this embodiment are especially effective when the luminous wavelength of the LED chip is located at near-ultraviolet zone.

(3) Translucent Covering Member 8:

The configuration of the translucent covering member 8 may differ depending on the configuration and application of the LED lighting apparatus. That is, the configuration of the translucent covering member 8 may be cup-like or plate-like for instance.

Next, the examples of the LED lighting apparatus according to a first embodiment of the present invention as well as comparative examples will be explained as follows.

### EXAMPLES 1-8, COMPARATIVE EXAMPLES 1, 2

The LED lighting apparatus according to the following examples and comparative examples were manufactured by the following methods using the materials shown in the following Table 1.

TABLE 1

| | | | Matrix | | | | | |
|---|---|---|---|---|---|---|---|---|
| | Organic phosphor | | | | | | | NI Phase |
| | Kinds of | Chemical | | | Chemical | | | transition |
| | compound | formula | Kinds of compound | Maker, Product No. | formula | Δn | ε// | point |
| Ex. 1 | Eu rare | Formula | Fluorine-based | Chisso Petroleum | — | 0.1018 | 7 | 104 |
| | earth | (9) | nematic liquid | Chemistry Co., | | | | |
| | complex | | crystal | Ltd. LIXONN5052XX | | | | |
| Ex. 2 | Eu rare | Formula | Fluorine-based | Dainihon Ink | — | 0.088 | — | 85.9 |
| | earth | (9) | nematic liquid | Chemistry Co., | | | | |
| | complex | | crystal (Condensed | Ltd. RDP84902 | | | | |
| | | | system) | | | | | |
| Ex. 3 | Eu rare | Formula | Fluorine-based | — | Formula | 0.19 | 7 | 104 |
| | earth | (9) | nematic liquid | | (14) | | | |
| | complex | | crystal | | | | | |
| Ex. 4 | Eu rare | Formula | Cyanobiphenyl- | Merk | Formula | 0.225 | 19 | 61 |
| | earth | (9) | based nematic | E7 | (15) | | | |
| | complex | | liquid crystal | | | | | |
| Ex. 5 | Eu rare | Formula | Fluorine-based | Chisso Petroleum | — | 0.1018 | 7 | 104 |
| | earth | (10) | nematic liquid | Chemistry Co., | | | | |
| | complex | | crystal | Ltd. LIXONN5052XX | | | | |
| Ex. 6 | Polymeric | Formula | Fluorine-based | Chisso Petroleum | — | 0.1018 | 7 | 104 |
| | phosphor | (11) | nematic liquid | Chemistry Co., | | | | |
| | | | crystal | Ltd. LIXONN5052XX | | | | |
| Ex. 7 | Polymeric | Formula | Fluorine-based | Chisso Petroleum | — | 0.1018 | 7 | 104 |
| | phosphor | (12) | nematic liquid | Chemistry Co., | | | | |
| | | | crystal | Ltd. LIXONN5052XX | | | | |
| Ex. 8 | Polymeric | Formula | Fluorine-based | Chisso Petroleum | — | 0.1018 | 7 | 104 |
| | phosphor | (13) | nematic liquid | Chemistry Co., | | | | |
| | | | crystal | Ltd. LIXONN5052XX | | | | |
| Comp. | Eu rare | Formula | Fluorinated | Du Pont | Formula | — | — | — |
| Ex. 1 | earth | (9) | polymer | Teflon AF | (16) | | | |
| | complex | | | | | | | |
| Comp. | Polymeric | Formula | Fluorinated | Du Poont | Formula | — | — | — |
| Ex. 2 | phosphor | (11) | polymer | Teflon AF | (16) | | | |

As for the Eu complex fluorescent substance in Examples 1 to 4 and Comparative Example 1, the compound represented by the following formula (13) was employed.

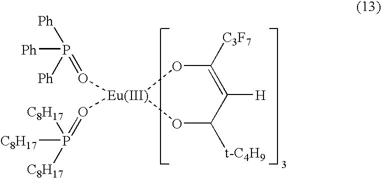

As for the Eu complex fluorescent substance in Example 5, the compound represented by the following formula (14) was employed.

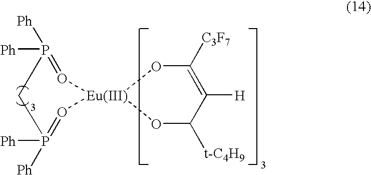

As for the polymeric fluorescent substance in Example 6 and Comparative Example 2, the compound (average molecular weight: 35,000) represented by the following formula (15) was employed.

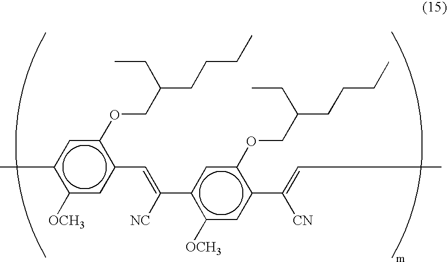

As for the polymeric fluorescent substance in Example 7, the compound (average molecular weight: 10,000) represented by the following formula (16) was employed.

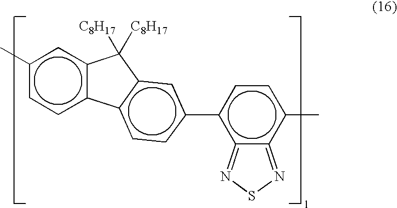

As for the polymeric fluorescent substance in Example 8, the compound (average molecular weight: 80,000) represented by the following formula (17) was employed.

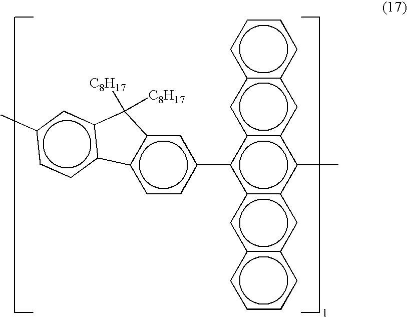

As for the liquid crystalline compound in Example 3, the compound represented by the following formula (18) was employed.

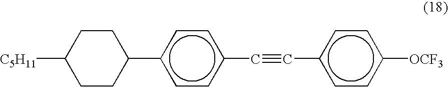

As for the liquid crystalline compound in Example 4, a mixture of the compounds A, B, C and D represented respectively by the aforementioned formulas (4) to (7) was employed. Incidentally, the ratio based on the molecular weight thereof was: A:B:C:D=51:25:16:8.

As for the fluoropolymer in Comparative Examples 1 and 2, the compound (average molecular weight: 4,000) represented by the following formula (19) was employed. 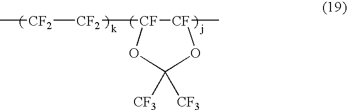
(where k and j are respectively a natural number).

The LED lighting apparatus according to Examples 1 to 5 and Comparative Example 1 were manufactured as shown below.

First of all, 1.5 wt % of each of the Eu complex fluorescent substances shown in Table 1 was dissolved in each of the matrices shown in Table 1 to create solutions. Then, the environmental atmosphere of these solutions was purged with nitrogen gas. By making use of these solutions, fluorescent layers were formed to manufacture the LED lighting apparatus (LED chip: 395 nm in luminous wavelength; 3.43 V in voltage; 20 mA in electric current) shown in FIG. 1 each provided with the fluorescent layer.

The LED lighting apparatus according to Examples 6 to 8 and Comparative Example 2 were manufactured as shown below.

First of all, 1.5 wt % of each of the polymeric fluorescent substances shown in Table 1 was dissolved in each of the matrices shown in Table 1 to create solutions, which were then heated for one hour at a temperature of not lower than the glass transition temperature thereof. Then, the resultant solutions were left to stand and subjected to filtration. Thereafter, the environmental atmosphere of these solutions was purged with nitrogen gas. By making use of these solutions, fluorescent layers were formed to manufacture the LED lighting apparatus (LED chip: 395 nm in luminous wavelength; 3.43 V in voltage; 20 mA in electric current) shown in FIG. 1 each provided with the fluorescent layer.

It was possible, by means of these fluorescent layers formed in this manner, to sufficiently absorb the light emitted from these LED chips.

By making use of these LED lighting apparatus manufactured as explained above, the initial luminous intensity, the luminous intensity after the lighting thereof for 3000 hours, and the luminous intensity after the heat treatment thereof for one hour at a temperature of 100° C. which was conducted after the lighting thereof for 3000 hours were measured. The measurement of these luminous intensities was performed by making use of a high precision luminance spectrometer (Instrument Systems Product No.CAS140B) under the conditions of: 20 mA and 3.43 V. The results of measurements thus obtained were shown in the following Table 2.

Incidentally, it may be noted that the luminous intensity ratio after the lighting for 3000 hours was determined by measuring the ratio of (luminous intensity after 3000-hour lighting)/(initial luminous intensity), and the luminous intensity ratio after the heat treatment for one hour at 100° C. was determined by measuring the ratio of (luminous intensity after one-hour heating at 100° C.)/(initial luminous intensity). The luminous intensity depends largely on the features of the organic fluorescent substance. Therefore, in order to facilitate the comparison in performance among the matrices, the luminous intensity ratios were calculated as described above.

TABLE 2

| | | | Luminosity | | Luminosity |
|---|---|---|---|---|---|
| | | | after 1 h | | ratio |
| | | Luminosity | heating | Luminosity ratio | after 1 h |
| | Initial | after 3000-hour | at 100° C./ | after 3000-hour | heating |
| | luminosity | lighting/mcd | mcd | lighting | at 100° C. |
| Ex. 1 | 136 | 96 | 115 | 0.71 | 0.85 |
| Ex. 2 | 120 | 90 | 110 | 0.75 | 0.92 |
| Ex. 3 | 130 | 95 | 115 | 0.73 | 0.88 |
| Ex. 4 | 90 | 75 | 80 | 0.83 | 0.89 |
| Ex. 5 | 177 | 120 | 150 | 0.68 | 0.85 |
| Ex. 6 | 300 | 230 | 290 | 0.77 | 0.97 |
| Ex. 7 | 350 | 280 | 330 | 0.80 | 0.94 |
| Ex. 8 | 280 | 240 | 260 | 0.86 | 0.93 |
| Comp. Ex. 1 | 45 | 30 | 28 | 0.67 | 0.62 |
| Comp. Ex. 2 | 70 | 55 | 50 | 0.79 | 0.71 |

As shown in Table 2, on the average, the LED lighting apparatus according to Examples 1 to 5 where the Eu complex fluorescent substances were employed were more excellent in the initial luminous intensity, in the ratio of luminous intensity after the lighting for 3000 hours, and in the ratio of luminous intensity after the one-hour heat treatment at 100° C. as compared with the LED lighting apparatus of Comparative Example 1. Likewise, the LED lighting apparatus according to Examples 6 to 8 where the polymeric fluorescent substances were employed were more excellent in the initial luminous intensity, in the ratio of luminous intensity after the lighting for 3000 hours, and in the ratio of luminous intensity after the one-hour heat treatment at 100° C. as compared with the LED lighting apparatus of Comparative Example 2.

Taking notice of examples and comparative examples where the same kind of compound was employed as an organic fluorescent substance, the LED lighting apparatus according to Examples 1 to 4 were more excellent in the initial luminous intensity, in the ratio of luminous intensity after the lighting for 3000 hours, and in the ratio of luminous intensity after the one-hour heat treatment at 100° C. as compared with the LED lighting apparatus of Comparative Example 1. Further, the LED lighting apparatus of Example 6 was more excellent in the initial luminous intensity and in the ratio of luminous intensity after the one-hour heat treatment at 100° C. as compared with the LED lighting apparatus of Comparative Example 2.

It will be clearly recognized from these results that the LED lighting apparatus according to these examples where matrices comprising a fluorine-based or cyanobiphenyl-based liquid crystalline compound exhibiting a nematic phase was employed were more excellent in luminous efficiency and in prolonging the life of LED lighting apparatus.

Further, as a whole, while the LED lighting apparatus according to Examples 1 to 8 where Eu complexes were employed were more prominent in the enhancement of the ratio of luminous intensity by the heat treatment in view of the results of the ratio of luminous intensity after the lighting for 3000 hours and of the ratio of luminous intensity after the one-hour heat treatment at 100° C., the LED lighting apparatus according to Comparative Examples 1 and 2 indicated deterioration of the ratio of luminous intensity due to the heat treatment.

It will be recognized from these results that the fluidity of the matrixes of the examples was enhanced by the treat treatment thereof, thereby making it possible to suppress the local deterioration of the fluorescent layers, resulting in an increase of the luminous intensity of the LED lighting apparatus.

Further, the LED lighting apparatus according to Examples 1 to 3 were higher in the initial luminous intensity as compared with the LED lighting apparatus of Example 4.

It will be recognized from these results that if the refractive index anisotropy of liquid crystalline compound is 0.20 or less, it is possible to enhance the initial luminous intensity.

Further, the LED lighting apparatus according to Examples 6 to 8 were higher in the initial luminous intensity as compared with the LED lighting apparatus of Examples 1 to 5.

It will be recognized from these results that the polymeric fluorescent substances were higher in luminous intensity as compared with the Eu complexes.

Next, the features of the fluorescent layer of the LED lighting apparatus of Examples 1 to 5 after the lighting thereof for 3000 hours will be explained with reference to FIG. 2. Further, the features of the fluorescent layer of the LED lighting apparatus of Comparative Example 1 after the lighting thereof for 3000 hours will be explained with reference to FIG. 3. Incidentally, the features of the base body 1, LED chip 6 and translucent covering member 8, excluding the fluorescent layer, are the same with those shown in FIG. 1.

As shown in FIG. 2, in the cases of the fluorescent layers of the LED lighting apparatus of Examples 1 to 5, the rare earth complex fluorescent substance 9 was excellent in dispersibility to the matrix 10 formed of a fluorine-based or cyanobiphenyl-based liquid crystalline compound exhibiting a nematic phase, thus preventing the generation of voids which may result from the deterioration of the fluorescent layer.

In contrast, as shown in FIG. 3, the fluorescent layer of the LED lighting apparatus of Comparative Examples 1 included not only voids 12 of large size at a region near the LED chip 6 but also voids 12 of small size which were generated at various regions on manufacturing the LED lighting apparatus. Further, the rare earth complex fluorescent substance 9 was poor in dispersibility to the matrix 10 formed of a fluoropolymer, thus generating segregation.

Next, a second embodiment of the present invention will be explained as follows.

The LED lighting apparatus according to the second embodiment of the present invention is featured in that it comprises an LED chip; a light-emitting layer which is disposed on the light-emitting side of the LED chip and contains a fluorescent substance; and a damp proof layer which is disposed on a surface of the light-emitting layer which is located opposite to the surface facing the LED chip and contains a compound which is liquid or exhibits a liquid crystal phase at room temperature.

In the case of the LED lighting apparatus according to the second embodiment of the present invention, it is preferable to employ, as a liquid compound, a compound having a siloxane bond.

As for the compound which is liquid or exhibits a liquid crystal phase, the compounds having a molecular structure represented by any one of the following formulas (20), (21), (22) and (23) may be used and the refractive index anisotropy of the moisture resistive layer may be less than 0.2. 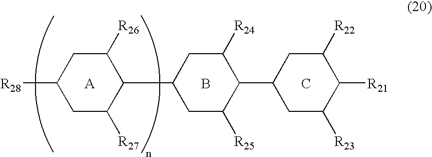
(where A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and n is an integer ranging from 0 to 3); 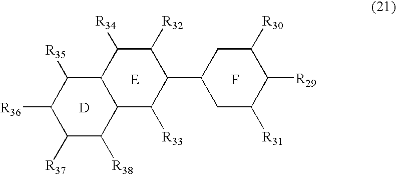
(where D, E and F may be the same or different and are individually benzene ring, cyclohexyl ring, cyclohexene ring, pyridine ring or pyrimidine ring; and R₂₉ to R₃₈ may be the same or different and are individually hydrogen atom, fluorine atom, alkyl group, alkoxy group, cyano group or isocyanate group wherein at least one of R₂₉ to R₃₈ include fluorine atom and/or cyano group); 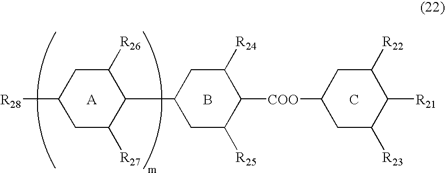
(where A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and m is an integer ranging from 0 to 3); 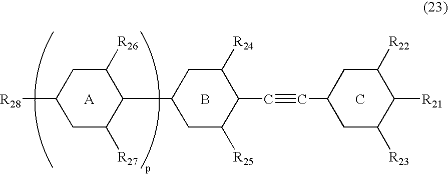
(where A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and p is an integer ranging from 0 to 3).

Further, as for the compounds exhibiting a liquid crystal phase, it is possible to employ at least one compound selected from the group consisting of β-diketone-based metal complex, phthalocyanine-based metal complex, dithiolene-based metal complex, porphyrin-based metal complex, metal (II) carboxylate-based binuclear complex and bis (glyoxymate) metal (II)-based compound.

In the LED lighting apparatus according to the second embodiment of the present invention, the moisture resistive layer may be liquid or formed of a gelated material of a compound exhibiting a liquid crystal phase. Further, this moisture resistive layer may be such that contains a hygroscopic organic or inorganic compound which is dissolved or dispersed therein.

As for the inorganic compound, it is possible to employ at least one compound selected from the group consisting of P₂O₅, Mg(ClO₄), SiO₂, CaSO₄, CaCl₂, CuSO₄ and MgSO₄. It is also possible to employ an organic coloring matter as the aforementioned organic compound.

The moisture resistive layer may be disposed so as to surround the light-emitting layer.

According to the second embodiment of the present invention, it is possible to provide an LED lighting apparatus with an improved life wherein the light-emitting layer thereof is also improved in moisture preventive effect.

The LED lighting apparatus according to the second embodiment of the present invention will be explained in detail.

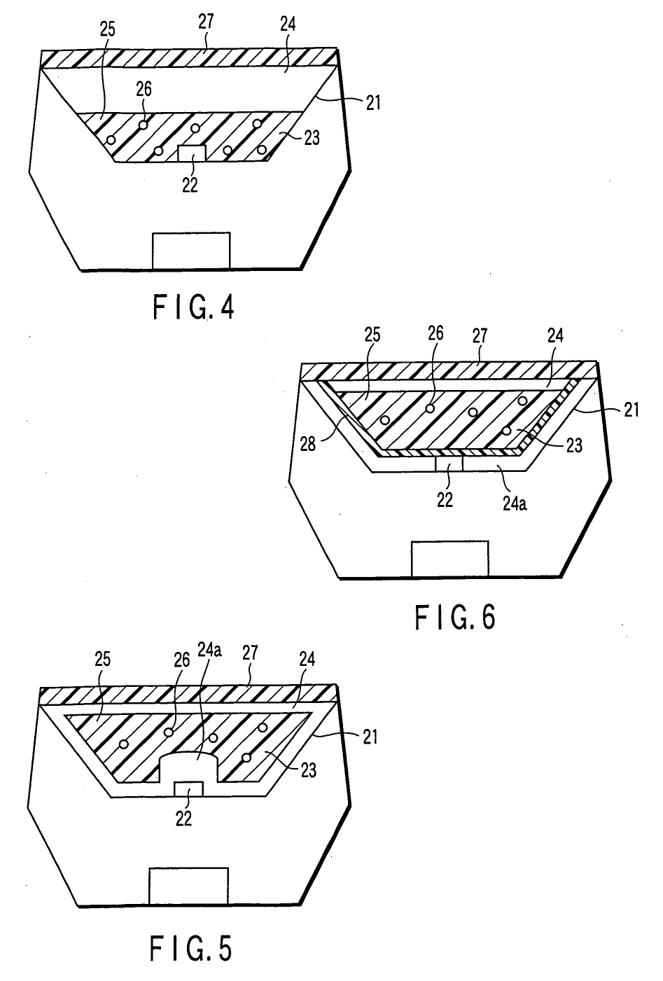

As shown in FIG. 4, the LED lighting apparatus according to the second embodiment of the present invention is constructed such that an LED chip 22 is accommodated inside a plastic cell 21 and a light-emitting layer 23 is disposed on the LED chip 22, on which a damp proof layer 24 containing a compound which is liquid or exhibiting a liquid crystal phase at room temperature is disposed. The light-emitting layer 23 is formed of a polymeric matrix 25 in which fluorescent particles 26 are dispersed. A sealing layer 27 is deposited on the damp proof layer 24 to thereby retain the damp proof layer 24 exhibiting fluidity. Incidentally, by dissolving or dispersing a hygroscopic compound in the damp proof layer 24, the moisture preventive effect to the light-emitting layer 23 can be further enhanced.

As for the method to provide the fluorescent particles 26 with moisture preventive effects without necessitating the provision of the aforementioned damp proof layer 24, it is conceivable to form the polymeric matrix of the light-emitting layer by making use of a polymer which is exhibiting moisture preventive effects such as halogenated ethylene resin. However, it would be difficult to dissolve or uniformly disperse a fluorescent substance in such a resin.

Alternatively, it is also conceivable to place, as a damp proof layer, a resin layer made of a polymer which is exhibiting moisture preventive effects on the upper surface of the fluorescent layer. However, it would be impossible, in this case, to expect sufficient moisture preventive effects. For example, when this resin layer is disposed on the upper surface of the fluorescent layer, it may be certainly possible to prevent water behaving as liquid from penetrating into the fluorescent layer. However, part of water molecule behaving as gas would be permitted to pass through the resin layer and then through the polymeric matrix to reach the fluorescent particles, thus promoting the deterioration of the fluorescent particles. Alternatively, it may be possible to enhance the moisture preventive effects by increasing the thickness of the aforementioned damp proof layer. However, when the thickness of the damp proof layer is increased, the transparency thereof would be deteriorated, thus making it difficult to obtain a sufficient luminous intensity.

In contrast, in the case of the LED lighting apparatus according to the second embodiment of the present invention, a damp proof layer containing a compound which is liquid or exhibiting a liquid crystal phase at room temperature is disposed on the upper surface of the light-emitting layer, thereby remarkably enhancing the moisture preventive effects. When water molecule tries to pass through a medium exhibiting fluidity such as a compound which is liquid or exhibiting a liquid crystal phase at room temperature, the water molecule is caused to dissolve in the molecule of the medium. As a result, the water molecule is no longer capable of behaving as a gas. Thus, this water molecule is no longer capable of reaching the fluorescent substance in the light-emitting layer.

As for the compounds for constituting this damp proof layer, it is desirable to employ those which are incapable of generating a chemical reaction with materials constituting the light-emitting layer and which are excellent in transparency.

As for specific examples of the compound which is liquid at room temperature, it is preferable to employ compounds having siloxane bond which is excellent in water repellency. For example, it is possible to employ decamethyl tetrasiloxane, octamethyl trisiloxane, methyl polysiloxane, decamethyl cyclopentasiloxane, octamethyl cyclopentasiloxane, methylphenyl polysiloxane, etc.

As for specific examples of the compound which is exhibiting a liquid crystal phase, it is possible to employ those having molecular structures represented by the aforementioned formulas (20) to (23). In this case, in order to secure the transparency, it is preferable to employ the compounds which are capable of meeting the condition that the refractive index anisotropy of the damp proof layer as a whole is less than 0.2. Among these compounds, it is especially preferable, in viewpoint of water repellency, to employ those wherein at least one of the substituent groups thereof is occupied by fluorine atom.

Further, it is possible to employ a cyanobiphenyl-based liquid crystal as the compound which is exhibiting a liquid crystal phase. Alternatively, it is also possible to incorporate a little amount of the cyanobiphenyl-based liquid crystal into the fluorine-based liquid crystal. Since the cyanobiphenyl-based liquid crystal is large in polarity, it is possible to expect the effects thereof to adsorb water molecule.

As for the liquid crystal phase, it may be nematic phase, smectic phase or discotic phase. As for the compound which is exhibiting a liquid crystal phase, it is possible to employ liquid crystalline compounds having a substituent group having a siloxane bond. Incidentally, when liquid crystalline compounds having a siloxane bond as shown in the following formula (24) are employed, it is possible to expect a further enhanced moisture preventive effect on account of the advantages based on both of the siloxane bond and fluidity. 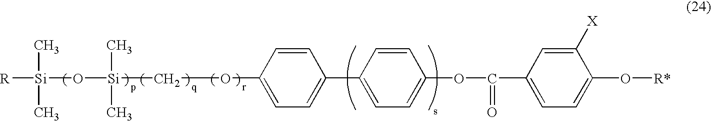
(where p is an integer ranging from 0 to 20; q is an integer ranging from 0 to 8; r is 0 or 1; s is an integer ranging from 0 to 2; R is alkyl group selected from the group consisting of methyl, ethyl and propyl, or a substituent group represented by the following formula (25); R* is alkyl group having an optically active center; and X is halogen); 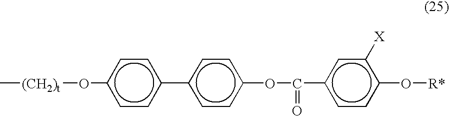
(where t is an integer ranging from 0 to 20; R* is alkyl group having an optically active center; and X is a halogen).

As for the other compounds exhibiting a liquid crystal phase, it is also possible to employ β-diketone-based metal complex, phthalocyanine-based metal complex, dithiolene-based metal complex, porphyrin-based metal complex, metal (II) carboxylate-based binuclear complex and bis(glyoxymate) metal (II)-based compound.

Incidentally, a gelling agent may be added to the aforementioned compound which is liquid or exhibiting a liquid crystal phase at room temperature to obtain a gelated material for use, thereby making it possible to sufficiently secure moisture preventive effects.

In the LED lighting apparatus according to the second embodiment of the present invention, it is preferable to dispose a sealing layer formed of a transparent resin, etc., on the upper surface of the damp proof layer. As for the materials for the sealing layer, it is preferable to employ materials which are excellent in transparency, moisture resistance and light resistance. For example, trifluorochloroethylene resin can be suitably employed as a material for the sealing layer.

Although there is not any particular limitation with respect to the materials for the fluorescent substance to be employed in the LED lighting apparatus according to the second embodiment of the present invention, examples of the fluorescent substance include organic fluorescent substances such as phenylene vinylene-based luminous polymers, carbazole-based luminous polymers, perylene-based luminous pigments, coumalin-based luminous pigments, etc.; rare earth complexes such as europium complex, terbium complex, gadolinium complex, etc.; and transition metal complexes.

Among these fluorescent substances, the rare earth complexes are more preferable since the fluorescence spectrum thereof is stable and the luminous intensity thereof is high. In particular, the europium complex which is exhibiting an especially strong luminous intensity is most preferable.

The moisture-preventing structure of the LED lighting apparatus according to the second embodiment of the present invention is effective in preventing the deterioration of not only the rare earth complexes but also the inorganic fluorescent substances. Namely, among the inorganic fluorescent substances, some of them are exhibiting water absorption, so that once the water absorption is permitted to take place, the luminous intensity of the fluorescent layer would be more likely to be extremely degraded. If the inorganic fluorescent substance is covered with an organic material for the purpose of preventing the water absorption of the inorganic fluorescent substance, it would lead to an increase of the manufacturing cost of the fluorescent fine particles. Whereas, according to the present invention, it is possible to provide inexpensive moisture-preventing measures for the inorganic fluorescent substance.

Next, specific examples of the second embodiment of the present invention will be explained as follows.

### EXAMPLE 9

The rare earth complex represented by the following formula (26) and a fluoropolymer (tradename: Dinion THV220, Sumitomo 3M Co., Ltd.) were dissolved in acetic acid and cured to obtain a phosphor-dispersed polymer. Then, by means of thermocompression bonding method, this phosphor-dispersed polymer was placed in the LED frame shown in FIG. 4 to form a light-emitting layer 23. Thereafter, a damp proof layer 24 formed of decamethyl tetrasiloxane was deposited on the light-emitting layer 23. Furthermore, a sealing layer 27 formed of trifluochloroethylene resin was deposited on the damp proof layer 24 to manufacture an LED lighting apparatus. 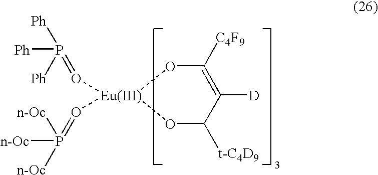
(where Ph is phenyl group; and Oc is octyl group).

By making of this LED lighting apparatus manufactured in this manner, the LED chip (luminous wavelength: 395 nm) 22 was permitted to radiate to measure the initial luminous intensity and luminous intensity half life. As a result, the initial luminous intensity was found to be 150 mcd and the luminous intensity half life was 35000 hours, thus demonstrating excellent results.

### CONVENTIONAL EXAMPLE 1

The same procedures as described in Example 9 were repeated except that the deposition of the damp proof layer 24 formed of decamethyl tetrasiloxane was omitted, thereby manufacturing an LED lighting apparatus. When the initial luminous intensity and the luminous intensity half life were measured in the same manner as performed in Example 9, the initial luminous intensity was found to be 160 mcd, indicating excellent results. However, the luminous intensity half life was 4000 hours, indicating inferior results. The reason for this may be ascribed to the fact that due to the penetration of water into the light-emitting layer, the fluorescent substance was caused to deteriorate.

### COMPARATIVE EXAMPLE 3

The same procedures as described in Example 9 were repeated except that trifluorochloroethylene was substituted for decamethyl tetrasiloxane in the formation of the damp proof layer 24, thereby manufacturing an LED lighting apparatus. When the initial luminous intensity and the luminous intensity half life of this LED lighting apparatus were measured in the same manner as performed in Example 9, the initial luminous intensity was found to be 140 mcd, indicating excellent results. However, the luminous intensity half life was 6000 hours, indicating inferior results. It will be recognized from these results that the damp proof layer formed of a solid polymer was ineffective in enhancing the life of the LED lighting apparatus.

### EXAMPLE 10

The same procedures as performed in Example 9 were repeated except that a mixture of compounds represented by the following formulas (27) to (31) was substituted for decamethyl tetrasiloxane in the formation of the damp proof layer, thereby manufacturing an LED lighting apparatus. When the initial luminous intensity and the luminous intensity half life of this LED lighting apparatus were measured in the same manner as performed in Example 1, the initial luminous intensity was found to be 140 mcd and the luminous intensity half life was 25000 hours, both indicating excellent results.

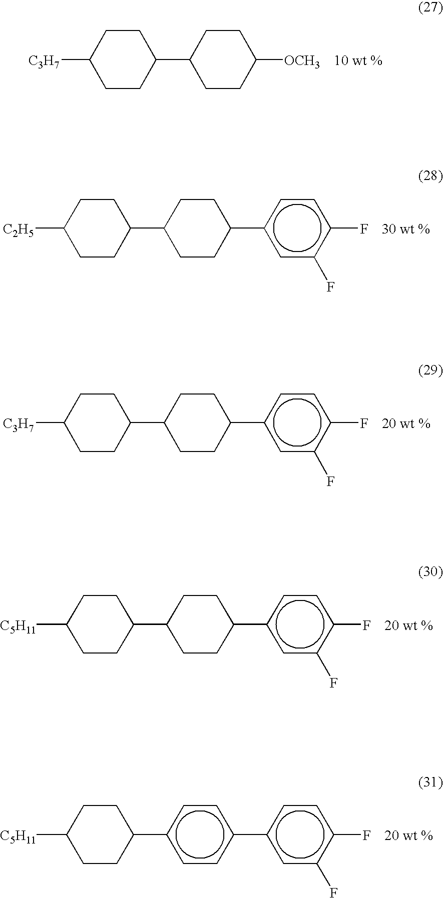

### EXAMPLE 11

The same procedures as performed in Example 9 were repeated except that a mixture of compounds represented by the following formulas (32) to (36) was substituted for decamethyl tetrasiloxane in the formation of the damp proof layer, thereby manufacturing an LED lighting apparatus. When the initial luminous intensity and the luminous intensity half life of this LED lighting apparatus were measured in the same manner as performed in Example 9, the initial luminous intensity was found to be 130 mcd and the luminous intensity half life was 30000 hours, both indicating excellent results.

Incidentally, the reason for generating more or less inferior results, i.e. 130 mcd, may be ascribed to the influence of the scattering of light.

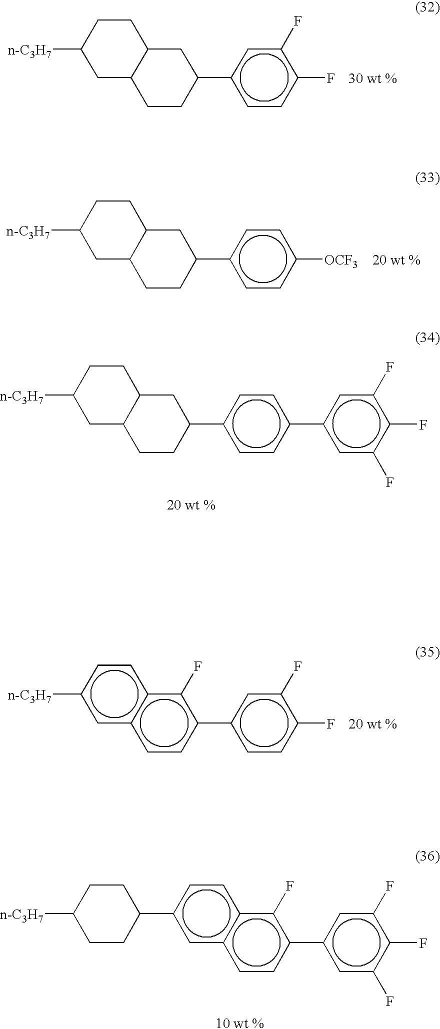

### EXAMPLE 12

The same procedures as performed in Example 9 were repeated except that a mixture of compounds represented by the following formulas (37) to (39) was substituted for decamethyl tetrasiloxane in the formation of the damp proof layer, thereby manufacturing an LED lighting apparatus. When the initial luminous intensity and the luminous intensity half life of this LED lighting apparatus were measured in the same manner as performed in Example 9, the initial luminous intensity was found to be 130 mcd and the luminous intensity half life was 30000 hours, both indicating excellent results.

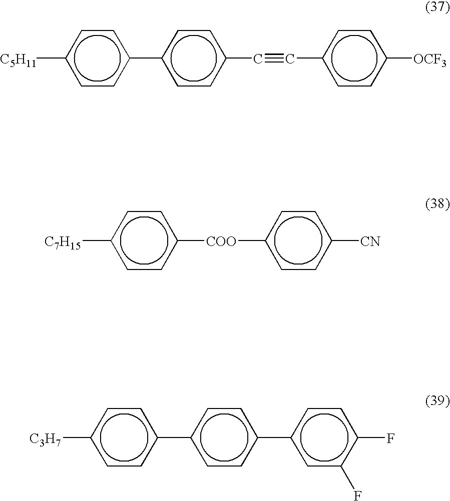

### EXAMPLE 13

The same procedures as performed in Example 9 were repeated except that 2,2,2-trifluoroethyl methacrylate and benzoyl peroxide were dissolved in a mixture of the compounds represented by the formulas (27) to (31) and employed in Example 10 to obtain a solution and that the resultant solution was applied to the upper surface of the light-emitting layer 23 and heated to gelate the layer of the solution to form the damp proof layer, thereby manufacturing an LED lighting apparatus. When the initial luminous intensity and the luminous intensity half life of this LED lighting apparatus were measured in the same manner as performed in Example 9, the initial luminous intensity was found to be 130 mcd and the luminous intensity half life was 25000 hours, both indicating excellent results.

### EXAMPLE 14

The same procedures as performed in Example 9 were repeated except that calcium chloride fine powder was dispersed in decamethyl tetrasiloxane to form the damp proof layer 24, thereby manufacturing an LED lighting apparatus. When the initial luminous intensity and the luminous intensity half life of this LED lighting apparatus were measured in the same manner as performed in Example 9, the initial luminous intensity was found to be 125 mcd and the luminous intensity half life was 30000 hours, both indicating excellent results.

### EXAMPLE 15

The same procedures as performed in Example 9 were repeated except that the yellow organic pigment represented by the following formula (40) was dissolved at a ratio of 0.1 wt % in decamethyl tetrasiloxane to form the damp proof layer 24, thereby manufacturing an LED lighting apparatus. When the initial luminous intensity and the luminous intensity half life of this LED lighting apparatus were measured in the same manner as performed in Example 9, the initial luminous intensity was found to be 145 mcd and the luminous intensity half life was 40000 hours, both indicating very excellent results.

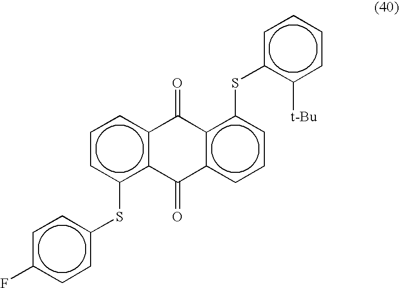

### EXAMPLE 16

The same procedures as performed in Example 9 were repeated except that the compound (β-diketone-based metal complex) represented by the following formula (41) was dissolved at a ratio of 0.05 wt % in a mixture of the compounds represented by the formulas (27) to (31) and employed in Example 10 to form the damp proof layer 24, thereby manufacturing an LED lighting apparatus. When the initial luminous intensity and the luminous intensity half life of this LED lighting apparatus were measured in the same manner as performed in Example 9, the initial luminous intensity was found to be 130 mcd and the luminous intensity half life was 30000 hours, both indicating excellent results.

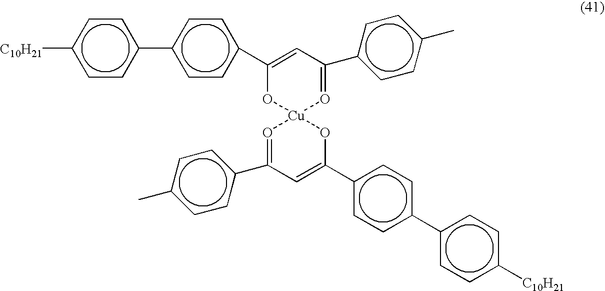

As described above, the LED lighting apparatus (Examples 9 to 16) all falling within the scope of the present invention and employing damp proof layers each containing a compound which was liquid or exhibiting a liquid crystal phase at room temperature were all excellent in the initial luminous intensity and in the luminous intensity half life. In contrast, it will be recognized that the LED lighting apparatus (Conventional Example 1) having no damp proof layer as well as the LED lighting apparatus (Comparative Example 3) provided with a damp proof layer formed of a solid fluorinated resin were all incapable of preventing the deterioration of the fluorescent substance, thus indicating very poor life thereof.

### EXAMPLE 17

The same procedures as performed in Example 9 were repeated except that an equivolume mixture consisting of three kinds of compounds represented by the following formulas (42), (43) and (44) was dissolved at a ratio of 0.5 wt % in a mixture of the compounds represented by the formulas (27) to (31) and employed in Example 10 to form the damp proof layer 24, thereby manufacturing an LED lighting apparatus. When the initial luminous intensity and the luminous intensity half life of this LED lighting apparatus were measured in the same manner as performed in Example 9, the initial luminous intensity was found to be 125 mcd and the luminous intensity half life was 40000 hours, both indicating excellent results.

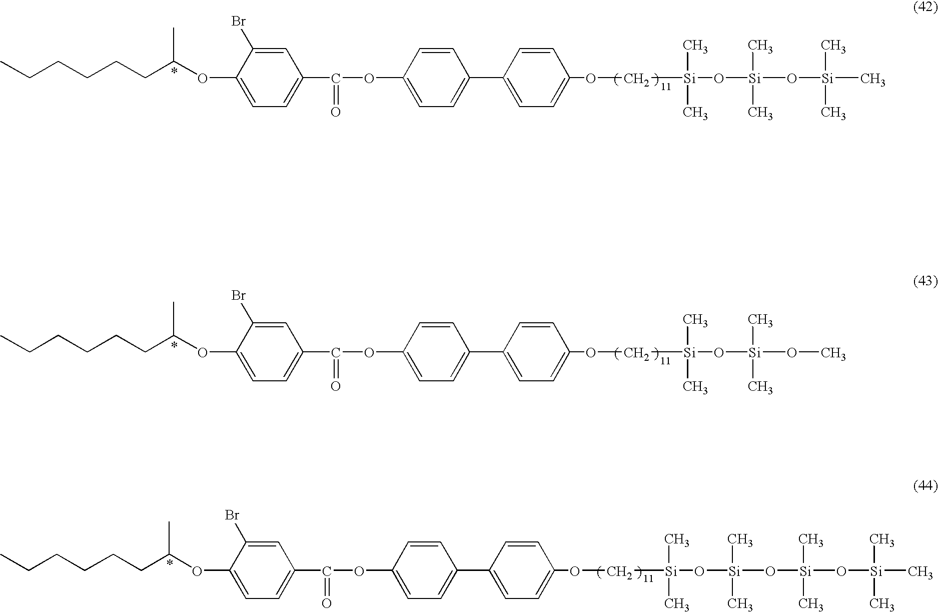

### EXAMPLE 18

50 μL of decamethyl tetrasiloxane was introduced drop-wise into an LED frame to form a film 24a prior to the formation of the light-emitting layer. Then, by means of thermocompression bonding method, the phosphor-dispersed polymer which was manufactured in Example 9 was added to the surface of the film 24a in the LED frame to form the light-emitting layer 23. Thereafter, the LED frame was filled with decamethyl tetrasiloxane to cover the entire surface of the light-emitting layer 23 with a damp proof layer 24 formed of decamethyl tetrasiloxane. Thereafter, a sealing layer 27 formed of trifluochloroethylene resin was deposited on the damp proof layer 24 to manufacture the LED lighting apparatushown in FIG. 5. In the embodiment shown in FIG. 5, although the upper surface of the LED lighting apparatus was covered with the decamethyl tetrasiloxane film, the upper surface of the LED lighting apparatus may not be covered with such a film depending on the light-emitting characteristics thereof.

When the LED lighting apparatus thus obtained was permitted to radiate under the same conditions as in Example 9, the initial luminous intensity was found to be 160 mcd and the luminous intensity half life was 45000 hours, both indicating excellent results. It was assumed that, in the case of the LED lighting apparatus according to this example, since the light-emitting layer was entirely covered with a damp proof layer, the luminous intensity half life was permitted to be further prolonged.

### EXAMPLE 19

The same procedures as performed in Example 9 were repeated except that decamethyl tetrasiloxane was applied drop-wise to the inner surface of an LED frame and then, a PFA resin film 28 having a thickness of 50 μm was formed on the inner surface of an LED frame. Thereafter, the LED lighting apparatus shown in FIG. 6 was manufactured in the same manner as described in Example 9 except that, by means of thermocompression bonding method, the phosphor-dispersed polymer prepared in Example 9 was applied over the PFA resin film 28 to place it in the LED frame. In this example, the upper surface of the LED was not covered with the film 24a.

When the initial luminous intensity and the luminous intensity half life of this LED lighting apparatus were measured in the same manner as performed in Example 9, the initial luminous intensity was found to be 150 mcd and the luminous intensity half life was 50000 hours, both indicating excellent results.

It was assumed that, in the case of the LED lighting apparatus according to this example, since the PFA resin film 28 was interposed, as a partitioning film, between the damp proof layer 24 of the inner surface of the LED frame and the light-emitting layer 23, the fluorescent substance 26 was prevented from eluting into the damp proof layer 24, thereby making it possible to further prolong the luminous intensity half life as compared with the LED lighting apparatus of Example 18.

### EXAMPLE 20

The same procedures as performed in Example 18 were repeated except that a liquid crystal mixture employed in Example 11 was substituted for decamethyl tetrasiloxane in the manufacture of an LED lighting apparatus. When the initial luminous intensity and the luminous intensity half life of this LED lighting apparatus were measured in the same manner as performed in Example 9, the initial luminous intensity was found to be 140 mcd and the luminous intensity half life was 40000 hours, both indicating excellent results.

### EXAMPLE 21

Three kinds of inorganic fluorescent substances consisting of a red phosphor, a green phosphor and a blue phosphor were mixed together to prepare a fluorescent substance, which was then uniformly dispersed in the polymer employed in Example 9 to prepare a white phosphor-dispersed polymer.

As for the blue phosphor, a phosphor represented by a chemical formula: Sr₅(PO₄)₃Cl:Eu and having a luminous peak wavelength of 445 nm was employed. As for the green phosphor, a phosphor represented by a chemical formula: 3(Ba,Mg)_{0.8}Al₂O₃:Eu,Mn and having a luminous peak wavelength of 514 nm was employed. As for the red phosphor, a phosphor represented by a chemical formula: Y₂O₂S:Eu and having a luminous peak wavelength of 624 nm was employed.

The same procedures as performed in Example 18 were repeated except that the aforementioned white phosphor-dispersed polymer was employed in the manufacture of an LED lighting apparatus. When the initial luminous intensity and the luminous intensity half life of this LED lighting apparatus were measured in the same manner as performed in Example 9, the initial luminous intensity was found to be 350 mcd and the luminous intensity half life was 40000 hours, both indicating excellent results.

### EXAMPLE 22

The same procedures as performed in Example 19 were repeated except that the white phosphor-dispersed polymer prepared in Example 21 was employed in the manufacture of an LED lighting apparatus. When the initial luminous intensity and the luminous intensity half life of this LED lighting apparatus were measured in the same manner as performed in Example 9, the initial luminous intensity was found to be 330 mcd and the luminous intensity half life was 50000 hours, both indicating excellent results.

### EXAMPLE 23

The fluorescent substance employed in Example 21 was dispersed in silicone monomer and thermally polymerized to prepare a phosphor-dispersed polymer. Then, the same procedures as employed in Example 22 were repeated except that this phosphor-dispersed polymer was employed in the manufacture of an LED lighting apparatus. When the initial luminous intensity and the luminous intensity half life of this LED lighting apparatus were measured in the same manner as performed in Example 9, the initial luminous intensity was found to be 380 mcd and the luminous intensity half life was 50000 hours, both indicating excellent results.

### COMPARATIVE EXAMPLE 4

The same procedures as employed in Conventional Example 1 were repeated except that the phosphor-dispersed polymer prepared in Example 21 was employed in the manufacture of an LED lighting apparatus. When the initial luminous intensity and the luminous intensity half life of this LED lighting apparatus were measured in the same manner as performed in Example 9, the initial luminous intensity was found to be 350 mcd, indicating excellent results but the luminous intensity half life was only 4000 hours, indicating inferior results.

The reason for this may be ascribed to the fact that due to the penetration of water into the light-emitting layer, the luminous intensity was caused to deteriorate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An LED lighting apparatus which comprises:
an LED chip; and
a light-emitting layer which is disposed on light-emitting side of the LED chip and including an organic fluorescent substance and a matrix containing, as a main component, a fluorine-based or cyanobiphenyl-based liquid crystalline compound exhibiting a nematic phase.

2. The LED lighting apparatus according to claim 1, wherein the liquid crystalline compound is a fluorine-based liquid crystalline compound exhibiting a refractive index anisotropy of not more than 0.20.

3. The LED lighting apparatus according to claim 1, wherein the organic fluorescent substance is a rare earth complex fluorescent substance.

4. The LED lighting apparatus according to claim 3, wherein the rare earth complex fluorescent substance is an Eu complex fluorescent substance provided with at least one of the ligands represented by the following formula (8) and (9) and with a ligand represented by the following formula (10): 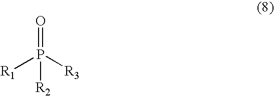
(wherein R₁, R₂ and R₃ may be the same or different and are individually alkyl group, alkoxy group, phenyl group, substituted phenyl group, phenoxy group or substituted phenoxy group, said alkyl and alkoxy groups each having not more than 20 carbon atoms) 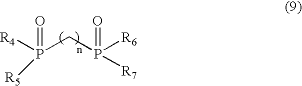
(wherein R₄, R₅, R₆ and R₇ may be the same or different and are individually alkyl group, alkoxy group, phenyl group, substituted phenyl group, phenoxy group or substituted phenoxy group, said alkyl and alkoxy groups each having not more than 20 carbon atoms; n is an integer ranging from 1 to 20) 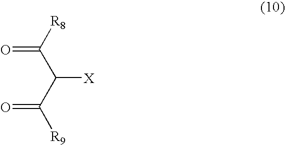
(wherein R₈ and R₉ may be the same or different and are individually alkyl group, alkoxy group, phenyl group, substituted phenyl group, phenoxy group or substituted phenoxy group, said alkyl and alkoxy groups each having not more than 20 carbon atoms; X is a group selected from the group consisting of H, D, F and alkyl group).

5. The LED lighting apparatus according to claim 4, wherein the Eu complex fluorescent substance contains a couple of the ligands represented by the formula (8), a ligand represented by the formula (9), and three ligands represented by the formula (10).

6. The LED lighting apparatus according to claim 5, wherein the Eu complex fluorescent substance contains a ligand represented by the formula (8) wherein R₁, R₂ and R₃ are individually phenyl group or substituted phenyl group, a ligand represented by the formula (8) wherein R₁, R₂ and R₃ are individually alkyl group, and ligands represented by the formula (10) wherein R₈ is perfluoroalkyl group, R₉ is alkyl group and X is a group selected from the group consisting of H, D and F.

7. The LED lighting apparatus according to claim 5, wherein the Eu complex fluorescent substance contains a ligand represented by the formula (9) wherein R₄, R₅, R₆ and R₇ are individually alkyl group, phenyl group or substituted phenyl group, and three ligands represented by the formula (10) wherein R₈ is perfluoroalkyl group, R₉ is alkyl group, and X is a group selected from the group consisting of H, D and F.

8. The LED lighting apparatus according to claim 1, wherein the organic fluorescent substance is a polymeric fluorescent substance having an average molecular weight ranging from 5,000 to 300,000 and represented by the following formula (11): 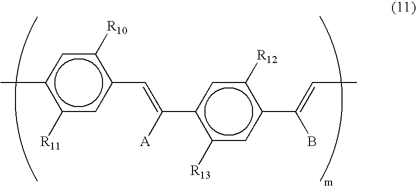
(wherein R₁₀, R₁₁, R₁₂ and R₁₃ may be the same or different and are individually alkyl group or alkoxy group; A and B may be the same or different and are individually cyano group or alkyl group; and m is a natural number.)

9. The LED lighting apparatus according to claim 1, wherein the organic fluorescent substance is a polymeric fluorescent substance having an average molecular weight ranging from 5,000 to 300,000 and represented by the following formula (12): 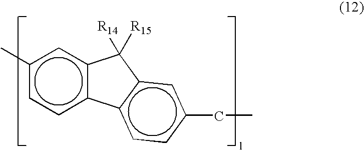
(wherein R₁₄ and R₁₅ may be the same or different and are individually alkyl group, alkoxy group, phenyl group or substituent phenyl group; C is aromatic group; and 1 is a natural number.)

10. The LED lighting apparatus according to claim 1, which further comprises a damp proof layer which is disposed on a first surface of the light-emitting layer located opposite to a second surface thereof facing the LED chip and contains a compound which is liquid or exhibits a liquid crystal phase at room temperature.

11. An LED lighting apparatus which comprises:
an LED chip;
a light-emitting layer which is disposed on a light-emitting side of the LED chip and contains an organic fluorescent substance; and
a damp proof layer which is disposed on a first surface of the light-emitting layer located opposite to a second surface thereof facing the LED chip and contains a compound which is liquid or exhibits a liquid crystal phase at room temperature.

12. The LED lighting apparatus according to claim 11, wherein the compound which is liquid contains a siloxane bond.

13. The LED lighting apparatus according to claim 11, wherein the compound which is liquid or exhibits a liquid crystal phase has a molecular structure represented by the following formula (20): 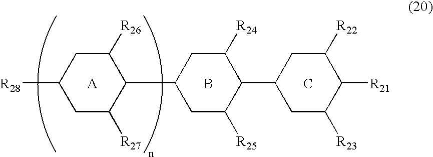
(wherein A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and n is an integer ranging from 0 to 3).

14. The LED lighting apparatus according to claim 11, wherein the compound which is liquid or exhibits a liquid crystal phase has a molecular structure represented by the following formula (21): 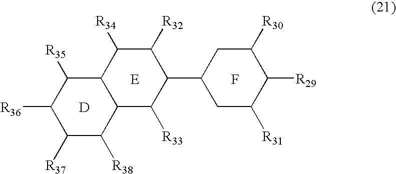
(wherein D, E and F may be the same or different and are individually benzene ring, cyclohexyl ring, cyclohexene ring, pyridine ring or pyrimidine ring; and R₂₉ to R₃₈ may be the same or different and are individually hydrogen atom, fluorine atom, alkyl group, alkoxy group, cyano group or isocyanate group wherein at least one of R₂₉ to R₃₈ include fluorine atom and/or cyano group).

15. The LED lighting apparatus according to claim 11, wherein the compound which is liquid or exhibits a liquid crystal phase has a molecular structure represented by the following formula (22): 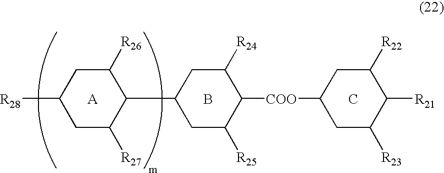
(wherein A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and m is an integer ranging from 0 to 3).

16. The LED lighting apparatus according to claim 11, wherein the compound which is liquid or exhibits a liquid crystal phase has a molecular structure represented by the following formula (23): 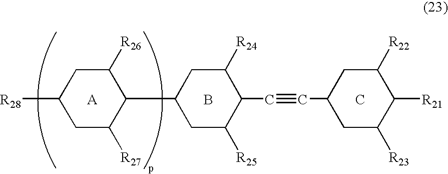
(wherein A, B and C may be the same or different and are individually benzene ring, cyclohexyl ring, cyclohexene ring, pyridine ring or pyrimidine ring; R₂₁ to R₂₈ may be the same or different and are individually hydrogen atom, fluorine atom, alkyl group, alkoxy group, cyano group or isocyanate group wherein at least one of R₂₁ to R₂₈ include fluorine atom and/or cyano group; and p is an integer ranging from 0 to 3).

17. The LED lighting apparatus according to claim 11, wherein the compound which is liquid or exhibits a liquid crystal phase is a liquid crystalline compound having a siloxane bond.

18. The LED lighting apparatus according to claim 11, wherein the compound which is liquid or exhibits a liquid crystal phase has a molecular structure represented by the following formula (24): 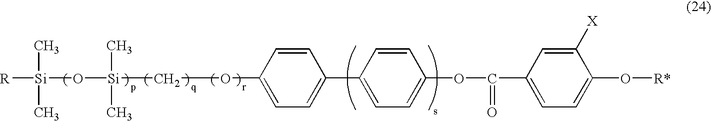
(wherein p is an integer ranging from 0 to 20; q is an integer ranging from 0 to 8; r is 0 or 1; s is an integer ranging from 0 to 2; R is alkyl group selected from the group consisting of methyl, ethyl and propyl, or a substituent group represented by the following formula (25); R* is alkyl group having an optically active center; and X is halogen); 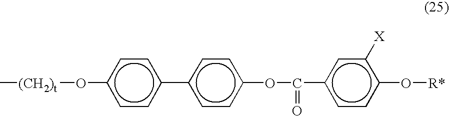
(wherein t is an integer ranging from 0 to 20; R* is alkyl group having an optically active center; and X is halogen).

19. The LED lighting apparatus according to claim 11, wherein the compound which exhibits a liquid crystal phase is at least one compound selected from the group consisting of β-diketone-based metal complex, phthalocyanine-based metal complex, dithiolene-based metal complex, porphyrin-based metal complex, metal (II) carboxylate-based binuclear complex and bis(glyoxymate) metal (II)-based compound.

20. The LED lighting apparatus according to claim 11, wherein the damp proof layer has a refractive index anisotropy of not more than 0.20.
